(19) United States
(12) Patent Application Publication
(10) Pub. No.: US 2006/0055265 A1
(43) Pub. Date: Mar. 16, 2006

(54) Printed circuit board motor

(76) Inventor: James Thomas Zalusky, Beavercreek, OH (US)

Correspondence Address: DINSMORE & SHOHL LLP, One Dayton Centre, Suite 1300, One South Main Street, Dayton, OH, 45402-2023, US

(21) Appl. No.: 10/942,505

(22) Filed: Sep. 16, 2004

(51) Int. Cl. H02K 5/00; H02K 21/12

(52) U.S. Cl. 310/156.32; 310/268; 310/DIG. 6; 310/207; 310/40 MM

(57) ABSTRACT

A printed circuit board motor is disclosed. The motor comprises a rotor plate embedded with magnets, an axle, and a printed circuit board stator. The printed circuit board comprises two conductors printed on the same surface or on opposite surfaces of the printed circuit board The two conductors produce alternating “square wave” patterns. The printed circuit board circuitry causes the direction of the current flow to reverse at intervals. The rotor rotates in response to the current flow in the stator. The rotation rate can be accurately controlled. The torque and average current consumption can be controlled by “chopping” the current with high frequency modulation whose duty cycle is proportional to the torque and average current consumption which will prolong the battery life of the motor.

### BACKGROUND OF THE INVENTION

The present invention generally relates to an electric motor incorporating permanent magnets and, in particular, to a motor having a rotor with a series of permanent magnets and a stator configured as a printed circuit board.

Electric motors of the type that include permanent magnets have become ubiquitous and part of everyday life. Such motors have many uses, including rotating small or light-weight parts of equipment in a precisely controlled manner. The basic electric design of this type of motor has not changed significantly over the years. Characteristically, current is switched to a series of conductor coils to produce a rotating field. The magnets in the motor are then acted upon by the rotating field, producing rotation of the rotor. Permanent magnet motors typically use batteries which have a limited life to produce the electric current needed to power the conductors.

It is desirable to incorporate an inexpensive electromagnetic motor in a number of applications. A significant part of the cost of such motors reside in their wire coils. It is also beneficial to have a two phase brushless system because it consumes half the energy of a typical two-phase permanent magnet motor, thereby, preserving and prolonging battery life. Finally, it is beneficial to have a permanent magnet motor which can be controlled very accurately.

Also, there is the need for a motor whose speed is independent of the level of current or voltage applied to the motor. It is also beneficial to a have a permanent magnet motor that allows variable torque and motor current so that during speed changes extra torque and current can be applied but during constant, steady rotation, the current consumption is reduced.

### BRIEF SUMMARY OF THE INVENTION

In accordance with one embodiment of the present invention, a printed circuit board motor is disclosed. The motor comprises a rotor that comprises a generally circular plate embedded with magnets that extend to the outer edge of the front surface of the rotor plate; an axle coupled to the back surface of the rotor plate; and a stator imprinted with a printed circuit board on its front surface that positioned adjacent and parallel to the front surface of the rotor plate. The printed circuit board comprises two conductors printed on the same surface or on opposite surfaces of the printed circuit board. The conductors are oriented 90° out of phase with each other. The two conductors produce alternating “square wave” patterns. The printed circuit board circuitry causes the direction of the current flow to reverse at prescribed intervals. The magnets embedded in the rotor plate provide a magnetic field that passes through the printed circuit board. The magnets around the edge of the rotor plate alternate north and south poles. The rotor rotates in response to the current flow in the stator. This rotation rate can be accurately controlled. The torque and average current consumption can be controlled by “chopping” the input current with relatively high frequency modulation whose duty cycle is proportional to the torque and average current consumption.

Accordingly, it is an object of the present invention to provide an inexpensive rotating electric motor that provides accurate control of rotation rate and allows for variable torque and motor current so that during speed changes extra torque and current can be applied, but during steady rotation, current consumption can be reduced, thereby, prolonging battery life.

It is also an object to increase battery life by reducing motor current to the amount needed to maintain the desired rotation rate, prolonging the battery life of the motor.

Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings:

FIG. 1A is a side view of the printed circuit board motor according to an embodiment of the present invention;

FIG. 1B is an overhead view of the printed circuit board motor according to an embodiment of the present invention;

FIG. 1C is a forward view of the printed circuit board motor according to an embodiment of the present invention;

FIG. 1D is a view of the front surface of the rotor illustrating the location of the embedded magnets according to an embodiment of the present invention;

FIGS. 2A and 2B illustrate the front and the back surfaces of the printed circuit board of the stator according to an embodiment of the present invention, without the printed windings;

FIG. 3 illustrates one conductor on the front surface of the printed circuit board of the stator according to an embodiment of the present invention;

FIG. 4 illustrates a second conductor on the back surface of the printed circuit board of the stator according to an embodiment of the present invention;

FIGS. 5A and 5B illustrate both conductors on the front and the back surfaces of the printed circuit board of the stator according to an embodiment of the present invention;

FIG. 6 illustrates the circuit diagram for the printed circuit board stator according to an embodiment of the present invention;

FIG. 7 is a diagram of the different inputs and outputs of the printed circuit board diagram of FIG. 6 according to an embodiment of the present invention.

In the following detailed description of the preferred embodiments, reference is made to the accompanying drawings that form a part hereof, and in which is shown by way of illustration, and not by way of limitation, a specific embodiment in which the invention may be practiced. It is to be understood that other embodiments may be utilized and that logical, mechanical and electrical changes may be made without departing from the spirit and scope of the present invention.

### DETAILED DESCRIPTION

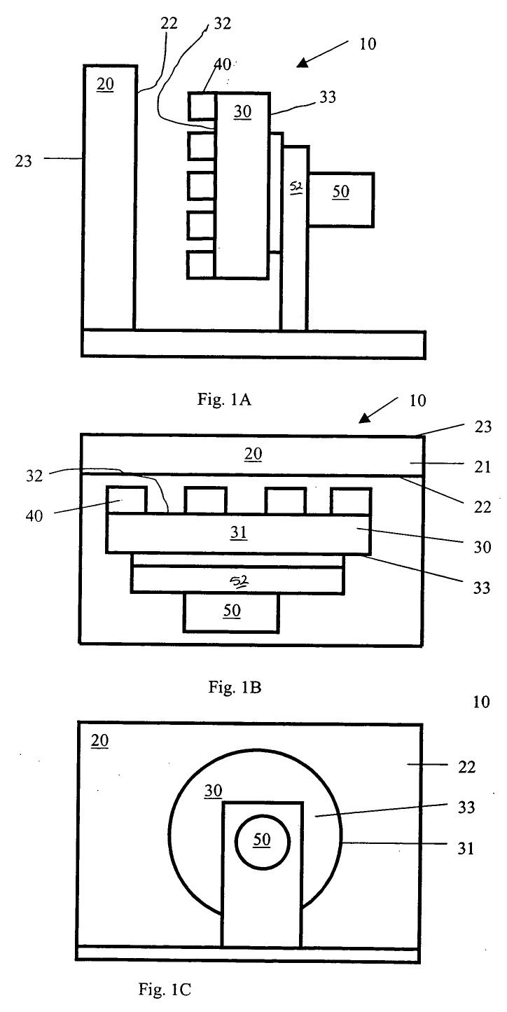

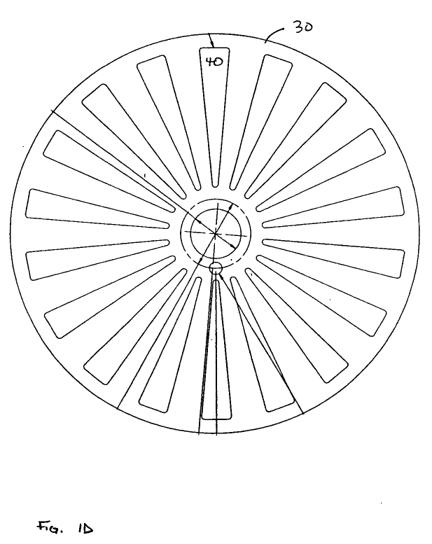

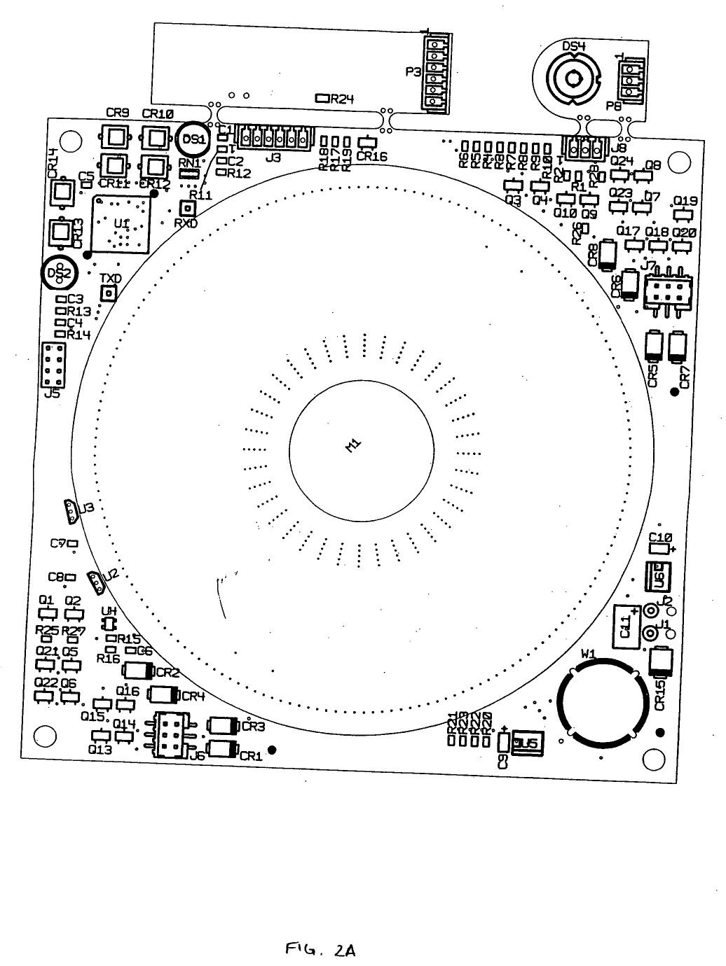

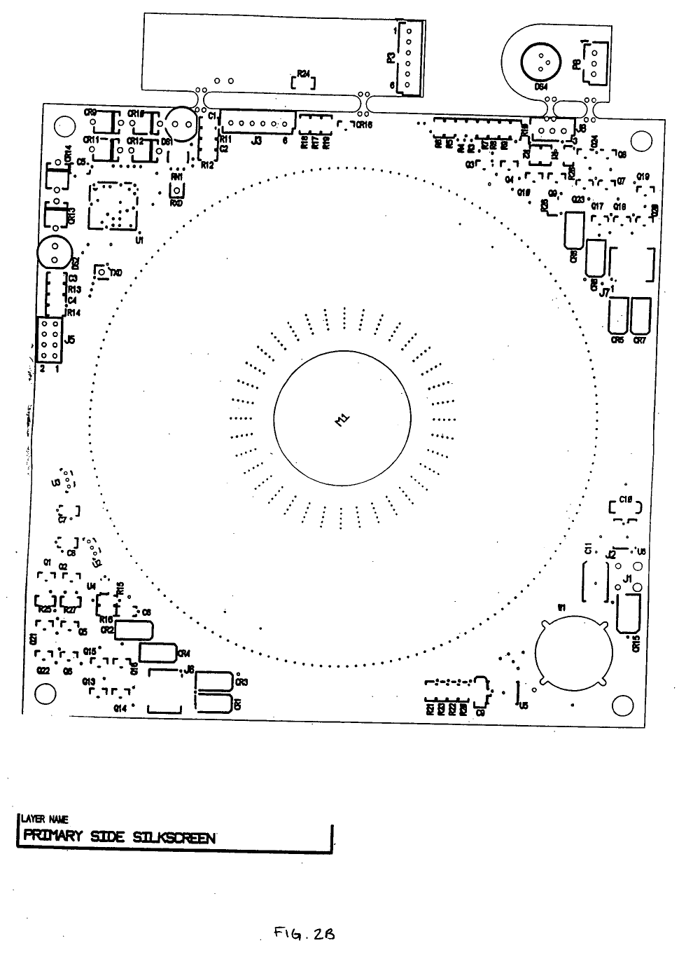

FIGS. 1A-D diagrammatically illustrate a printed circuit board motor 10 from several different viewpoints. A rotor 30 of the printed circuit board motor 10 comprises a plate 31 having a front surface 32 and a back surface 33. The rotor 30 has a plurality of magnets 40 mounted on and extended to the outer edge of the front surface 32 of the rotor plate 31 as seen in FIG. 1D. The magnets 40 may also be embedded into the front surface 32 of the rotor plate 31. The plurality of magnets 40 on the rotor 30 alternate their north and south poles. That is, proceeding around the periphery of the rotor 30, one encounters magnets with their north poles facing away from the rotor 30 interleaved with magnets with their south poles facing away from the rotor 30. The rotor plate 31 may be configured as a circular disc but other geometric shapes are possible. The rotor 30 is attached to an axle 50. The axle 50 rotates with the rotor 30, and may be attached to whatever apparatus is to be driven by the motor 10. The axle 50 may be journaled in an appropriated bearing which is supported by a support arm 52.

The stator 20 comprises a printed circuit board 21 having a front surface 22 and a back surface 23. In one embodiment, the printed circuit board 21 of the stator 20 can be part of a larger printed circuit board that controls the entire product and contains all the electronics for the product. In another embodiment, the printed circuit board 21 of the stator 20 controls only the printed circuit board motor 10. The front surface of the stator 20 is positioned across from, and parallel to, the front surface of the rotor 30. The plurality of magnets 40 on the rotor 30 extend from the rotor plate 31 at a distance that allows the magnetic fields produced by the magnets 40 to pass through the printed circuit board of the stator 20 and to prevent crosstalk. The rotor 30 and stator 20 do not touch.

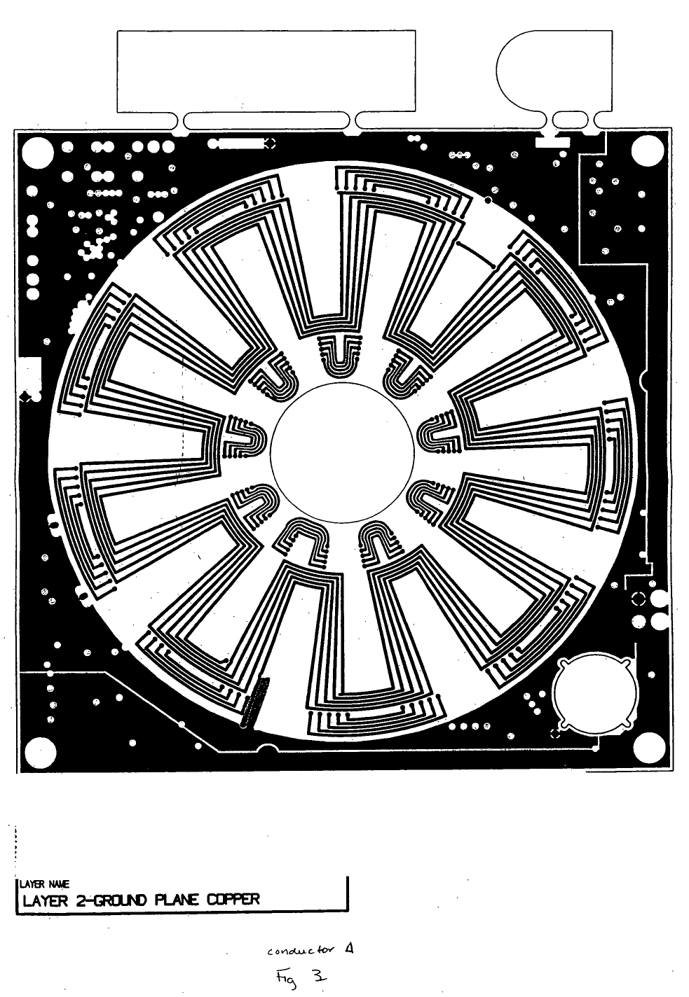

The front surface 22 of the printed circuit board 21 of the stator 20 is illustrated in FIG. 2A. A processor U1 can be mounted on the front surface 22 of the printed circuit board 21. Hall effect transducers U2 and U3 are also mounted on the front surface 22 of the printed circuit board 21. The back surface 23 of the printed circuit board 21 is illustrated in FIG. 2B.

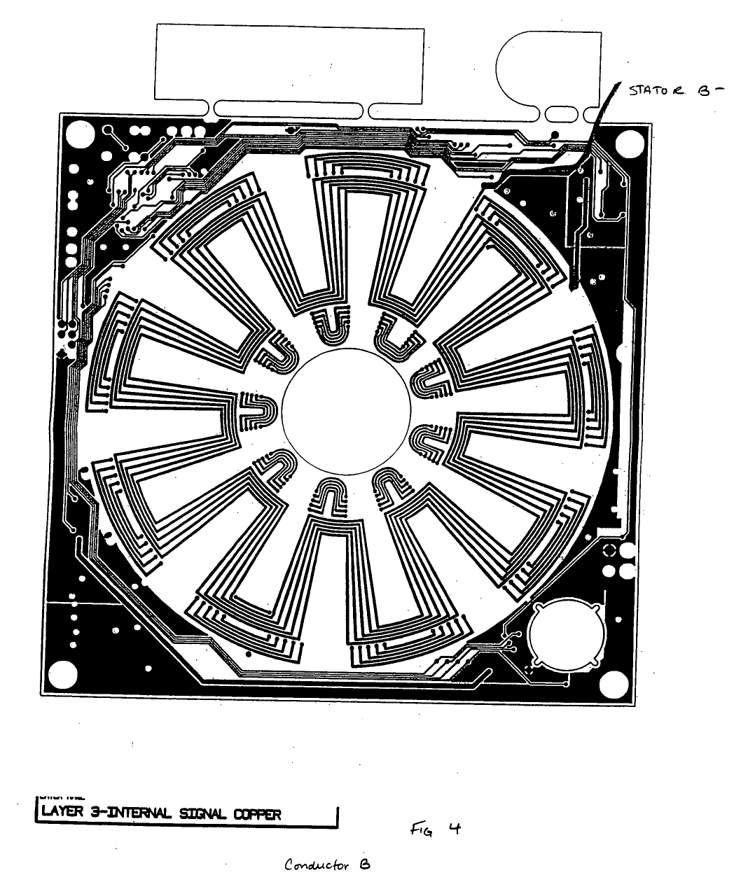

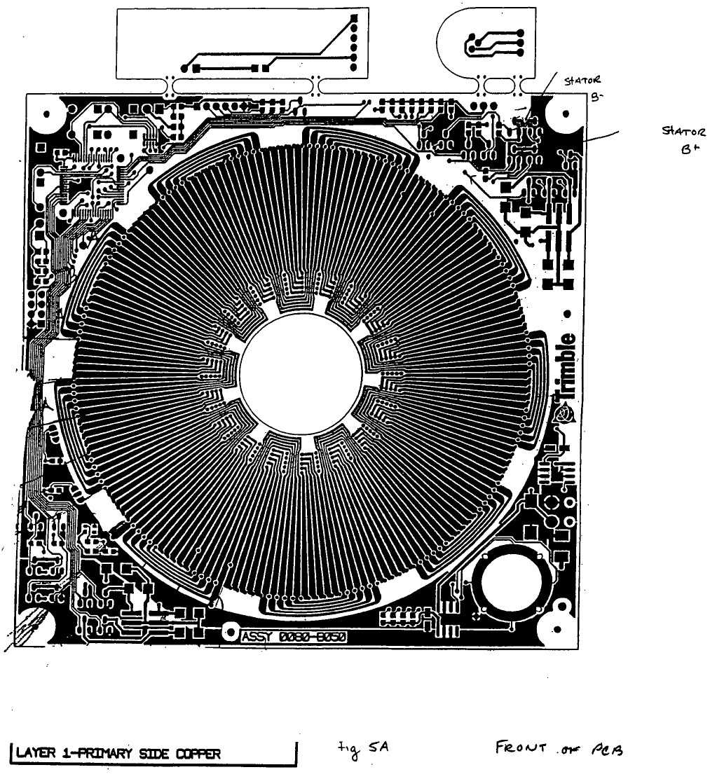

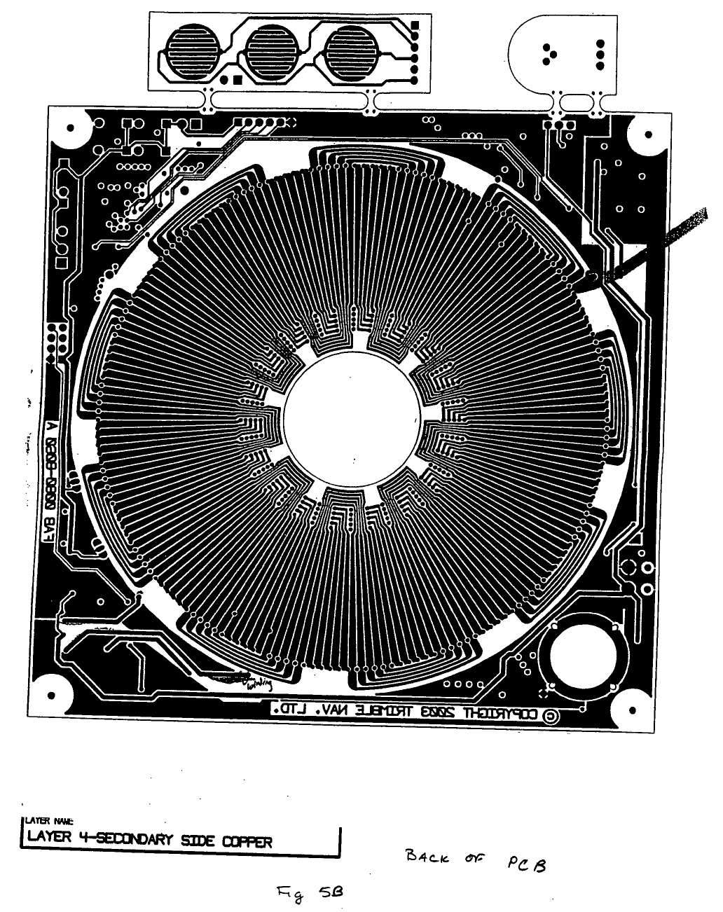

The printed circuit board can be made of any number of layers and made by any of the well know methods of the art. In one embodiment, a first layer of the conductor is printed on front surface 22 of the printed circuit board 21 and is illustrated in FIG. 3. This first layer of conductor can be printed in a conductive metal such as, for example, copper. A second layer of the conductor is printed on the back surface 23 of the printed circuit board 21 and is illustrated in FIG. 4. This second layer comprises the internal signal lines for the printed circuit board 21. FIGS. 5A-B illustrate the conductors with both positive and negative components of the two conductors as they are printed on the front surface 22 and the back surface 23 of the printed circuit board 21. FIG. 5A represents the conductor printed on the front surface 22 of the printed circuit board 21. FIG. 5B represents the conductor on the back surface 23 of the printed circuit board 21. The two front and back conductors are 90 degrees out of phase with each other and represent sinking and sourcing pairs. In another embodiment, the printed circuit board 21 can be single sided. In this embodiment, the two front and back conductors are printed on the single side and are connected by jumpers.

The two conductors produce alternating “square wave” patterns that are arranged in a circle. The processor U1 causes the direction of the current flow through the conductors to reversal at intervals resulting in the rotor 30 spinning. The processor U1 controls the current flow with high frequency modulation. In addition, the torque and average current consumption of the printed circuit board motor 10 can be controlled by the processor U1. The processor U1 controls the current by “chopping” it with relatively high frequency modulation. This relatively high frequency modulation has a duty cycle that is proportional to the torque and average current consumption. The rotor 30 rotates in response to the current flow in the printed circuit board 21. This rotation rate can be accurately controlled by the processor U1. Due to the method of alternating phases of the two conductors, speed is independent of current or voltage applied to the motor. Speed, torque and power consumption are, also, independently controlled.

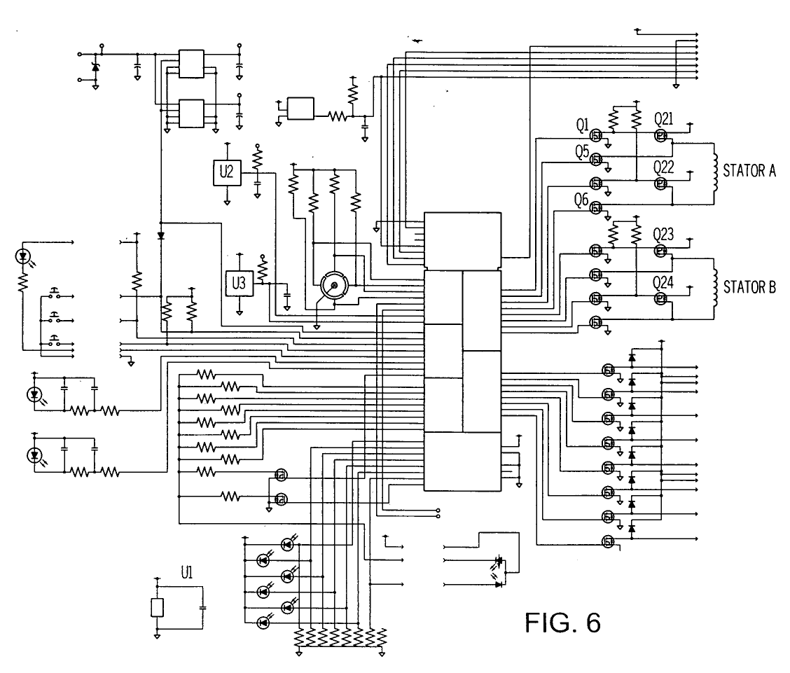

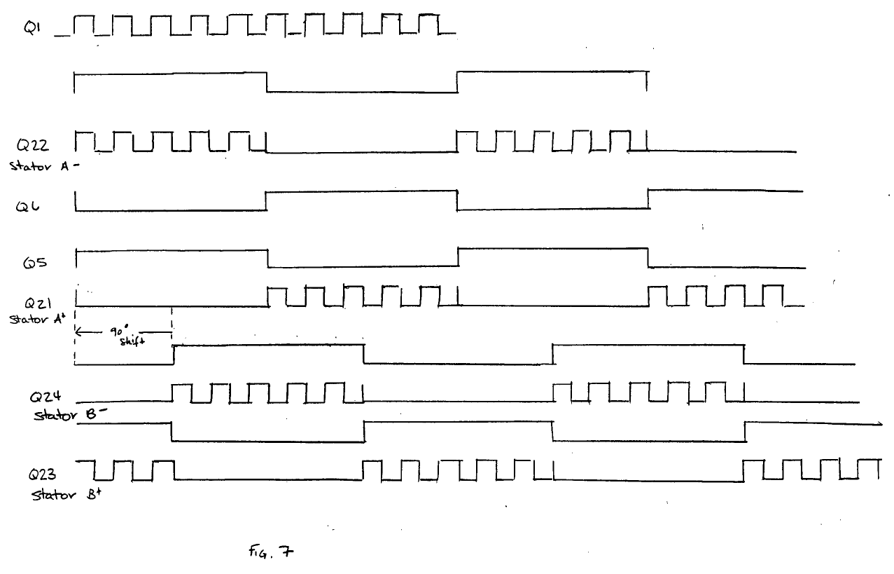

FIG. 6 illustrates the circuit diagram for the printed circuit board stator according to an embodiment of the present invention. The printed circuit board 21 has any number of surfaces. The stator A and B represent the two conductors that are 90° out of phase which other and that are printed on all of the surfaces of the printed circuit board 21. The two Hall effect transducers U2 and U3 and the processor U1 are also illustrated. The maximum gate to source voltage is +/−12 volts for a bridge field effect transistor (FET) or +/−3.5 volts for a 2N7002 printed circuit board FIG. 7 is a diagram of the different inputs and outputs of the circuit diagram of FIG. 6 according to an embodiment of the present invention. Q1 represents the battery voltage input produced by the processor U1. As illustrated, the input is a chopped wave input that has a frequency that is relatively high compared to the switching frequency required for the desired rotation rate of the printed circuit board motor 10. The frequency can be, for example, about eight kilohertz, resulting in a period, for example, of about 125 microseconds. Q21 and Q22 represent the alternating positive and negative outputs from the conductor printed on the front surface 22 of the printed circuit board 21 of the stator 20. Q21 designates the positive output and Q22 the negative output. Q23 and Q24 represent the alternating positive and negative outputs from the conductor printed on the back surface 23 of the printed circuit board 21 of the stator 20 that are 90 degrees out of phase with the positive and negative outputs from the conductor printed on the front surface of the printed circuit board of the stator 20. Q23 designates the positive output and Q24 the negative output. In addition, Q24 lags behind Q22 by a function of the desired rotation speed based on the speeds and geometry of the conductor patterns on the printed circuit board 21. The lag, for example, can be approximately 100 milliseconds. Q21, Q22, Q23 and Q24 represent the modulation effect of the chopped input current of Q1.

Because a chopped input wave is used, less electrical energy is needed to spin the rotor 30. Even though there is an increased need for current to start the printed circuit board motor 10 or to change the speed, the current consumption decreases once the rotor 30 is spinning at a constant steady speed, thereby lowering overall energy costs. Through the use of the chopped wave, half the effective electrical energy is used, thereby prolonging the battery life by twofold over the average printed circuit board motor life resulting in greater cost savings.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A printed circuit board motor, comprising:
a rotor comprising
a plate having a front and back surface, and
a plurality of spaced-apart magnets in which an air gap is defined between each magnet of said plurality of spaced-apart magnets, wherein said plurality of spaced-apart magnets are mounted adjacent to the outer edge of said plate rotor on said front surface thereof;
an axle coupled to said back surface of said plate in the center of said plate; and
a stator having a front surface and a back surface and said front surface being positioned adjacent and parallel to said front surface of said plate, said stator including:
a printed circuit board having at least two conductors; and
a processor for controlling application of power to said conductors.

2. The printed circuit board motor of claim 1, wherein said plate of said rotor is circular.

3. The printed circuit board motor of claim 1, wherein said printed circuit board of said stator further includes a plurality of Hall effect transducers.

4. The printed circuit board motor of claim 1, wherein said plurality of spaced-apart magnets are arranged adjacent the edge of said plate of said rotor such that magnets having outward facing north poles alternate with magnets having outward facing south poles around the edge of said plate.

5. The printed circuit board motor of claim 1, wherein each of said plurality of spaced-apart magnets protrudes a distance from the edge of said front surface of said plate of said rotor.

6. The printed circuit board motor of claim 1, wherein each of said plurality of spaced-apart magnets provides a magnetic field that passes through said printed circuit board of said stator.

7. The printed circuit board motor of claim 1, wherein said plurality of spaced-apart magnets are positioned relative to the edge of said front surface of said plate of said rotor such that field effect crosstalk is prevented.

8. The printed circuit board motor of claim 1, wherein said printed circuit board has a front surface and a back surface and wherein said at least two conductors are printed on opposite surfaces of said printed circuit board, wherein one of said at least two conductors is printed on said front surface of said stator and the other of said at least two conductor is printed on said back surface of said stator.

9. The printed circuit board motor of claim 1, wherein said at least two conductors are printed on said single surface of said printed circuit board, wherein said at least two conductors connected by jumper connections.

10. The printed circuit board motor of claim 1, wherein said at least two conductors are orientated 90° out of phase with each other around the periphery of said stator.

11. The printed circuit board motor of claim 1, wherein the current provided to one of said at least two conductors lags the current provided to the other of said at least two conductors.

12. The printed circuit board motor of claim 11, wherein said lag between said at least two conductors is a function of the desired rotation speed.

13. The printed circuit board motor of claim 1, wherein current is supplied to said two conductors as alternating square wave patterns.

14. The printed circuit board motor of claim 13, wherein the speed of rotation of said rotor is independent of the levels of current and voltage applied to said printed circuit board motor.

15. The printed circuit board motor of claim 1, wherein said processor causes direction of current flow through said conductors to reverse at intervals, resulting in rotation of said rotor.

16. The printed circuit board motor of claim 1, wherein said processor controls current flow through said conductors through the use of frequency modulation.

17. The printed circuit board motor of claim 16, wherein said frequency modulation has a duty cycle that is proportional to torque and average current consumption.

18. The printed circuit board motor of claim 17, wherein said torque and average current consumption is controlled by chopping the current at a relatively high frequency.

19. The printed circuit board motor of claim 18, wherein said current consumption decreases once said rotor is rotating at a constant speed.

20. The printed circuit board motor of claim 18, wherein said chopped current has a frequency that is relatively high compared to the switching frequency required for the desired rotation rate.
